(19) United States
(12) Patent Application Publication
(10) Pub. No.: US 2026/0279633 A1
(43) Pub. Date: Sep. 17, 2026

(54) FERRITE COMPOSITION AND MAGNETIC CORE COMPRISING SAME

(71) Applicant: LG INNOTEK CO., LTD., Seoul (KR)

(72) Inventors: Deok Hyeon KIM, Seoul (KR); Hyun Jl LEE, Seoul (KR); Sang Won LEE, Seoul (KR)

(21) Appl. No.: 18/873,776

(22) PCT Filed: May 9, 2023
(86) PCT No.: PCT/KR2023/006263

§ 371 Date: Dec. 11, 2024

(30) Foreign Application Priority Data
Jun. 23, 2022 (KR) 10-2022-0076916

(51) Int. Cl. H01F 1/34; C04B 35/26; H01F 3/08

(52) U.S. Cl. CPC H01F 1/344; C04B 35/2633; H01F 3/08; C04B 2235/3208; C04B 2235/3251; C04B 2235/3262; C04B 2235/3274; C04B 2235/3277; C04B 2235/3284

(57) ABSTRACT

A magnetic core, according to the present invention, comprises: a main composition including a manganese (Mn) component with an atomic ratio in the range of 0.74 to 0.76, a zinc (Zn) component with an atomic ratio in the range of 0.15 to 0.17, an iron (Fe) component with an atomic ratio in the range of 2.08 to 2.09, and a cobalt (Co) component with an atomic ratio in the range of 0.005 to 0.010; a magnetic ionic agent; and a non-magnetic additive, wherein the magnetic core has a core loss of 300 mW/cc or less at 80° C. to 100° C. under the conditions of 100 kHz frequency and a maximum magnetic flux density of 200 mT.

### TECHNICAL FIELD

Embodiments relate to a ferrite composition having minimized minimum loss and minimized loss increase rate as a function of temperature change, and a magnetic core containing the same.

### BACKGROUND ART

Recent continuous interest in and regulations on the environment has caused active development and market expanding of cores for magnetic components applicable to a wide operating temperature range. Accordingly, the importance of power components from TVs to electric fields is also increasing.

In general, magnetic cores that constitute inductors or transformers have a problem of difficulty in satisfying the reliability required for the surrounding environment such as low-temperature characteristics or thermal shock.

Power components and modules that use magnetic cores that constitute inductors or transformers may have increased energy loss depending on the operating environment of the power components and modules. Here, the operating environment may mean that heat generation of the components gradually increases with an increasing temperature within the operating temperature range as the module operates. Therefore, to compensate for this, higher energy for component heat dissipation and cooling may be required.

In addition, power components and modules that use magnetic cores may cause failure and damage to peripheral components (TFTs) due to heat generation, which may reduce electricity economy of next-generation platforms such as EVs that use electricity as a main power source.

Therefore, it is necessary to consider a method to reduce heat generation while reducing the loss of the magnetic core.

### DISCLOSURE

### Technical Problem

Embodiments provide a ferrite composition having minimized minimum loss and minimized loss increase rate as a function of temperature change, and a magnetic core containing the same.

In particular, embodiments provide a ferrite composition having minimized minimum loss and minimized loss increase rate as a function of temperature change by optimizing the composition of the magnetic ion agent, the composition of the main composition, and the amount of non-magnetic additive added.

The technical problems to be achieved by the present embodiments are not limited to the technical problems mentioned above and other technical problems not mentioned herein will be clearly understood from the description below by those skilled in the art to which the present embodiment pertains from the description below.

### Technical Solution

A magnetic core according to an embodiment may contain a main composition containing a manganese (Mn) component having an atomic ratio of 0.74 to 0.76, a zinc (Zn) component having an atomic ratio of 0.15 to 0.17, an iron (Fe) component having an atomic ratio of 2.08 to 2.09, and a cobalt (Co) component having an atomic ratio of 0.005 to 0.010, a magnetic ion agent, and a non-magnetic additive, wherein the magnetic core has a core loss of 300 mW/cc or less at 80 to 100° C., at a frequency of 100 kHz and at a maximum magnetic flux density of 200 mT.

In an example, the magnetic core may have a coercivity change rate of 7% to 20% at 25° C. to 140° C.

In an example, the magnetic core may have a change rate of the core loss of −6% to 18% at 25° C. to 140° C.

In an example, the magnetic core may have a change in the core loss less than 100 mW/cc at 25° C. to 140° C.

In an example, the magnetic core may a change in the core loss ranging from 60 mW/cc to 99 mW/cc.

In an example, the magnetic core may have an initial permeability of 3,000 or more.

In an example, the magnetic core may have an atomic ratio of the manganese (Mn) component to the zinc (Zn) component ranging from 4.40 to 4.60.

In an example, the magnetic ion agent may contain a compound (Fe+Co) of iron (Fe) and cobalt (Co).

In an example, an atomic ratio of the compound (Fe+Co) of iron (Fe) and cobalt (Co) of the magnetic ion agent may range from 2.08 to 2.10.

In an example, an atomic ratio of the cobalt (Co) component with respect to a total atomic ratio of the main composition may range from 0.005 to 0.01.

In an example, the non-magnetic additive may contain at least one of calcium oxide (CaO), niobium oxide (Nb₂O₅), or a mixture thereof.

A content of the calcium oxide (CaO) may be 400 ppm to 600 ppm.

A content of the niobium oxide (Nb₂O₅) may be 50 ppm to 600 ppm.

Also, the magnetic core may contain 21.2 wt % to 21.6 wt % of manganese oxide (MnO) containing the manganese component, 5.7 wt % to 6.1 wt % of zinc oxide (ZnO) containing the zinc component, 72 wt % to 72.7 wt % of iron oxide (Fe₂O₃) containing the iron component, and 0.3 wt % to 0.4 wt % of cobalt oxide (Co₃O₄) containing the cobalt component.

### Advantageous Effects

The ferrite composition and the magnetic core containing the same according to the embodiment may minimize the lowest loss of the magnetic core and minimize a loss increase rate depending on temperature change by optimizing the composition of the magnetic ion agent, the composition of the main composition, and the composition of the non-magnetic additive.

The effects that can be obtained from the present embodiment are not limited to the effects mentioned above and other effects not mentioned herein will be clearly understood by those skilled in the art to which the present embodiment pertains from the description below.

### DESCRIPTION OF DRAWINGS

FIG. 1 is a block diagram illustrating the configuration of a ferrite composition and a magnetic core containing the same according to one embodiment.

FIG. 2 is a graph showing a core loss change as a function of temperature change in the atomic ratio of the magnetic ion agent (Fe+Co) with respect to the magnetic core formed with the ferrite composition according to one embodiment.

FIG. 3 is a graph showing a core loss change depending on temperature change in the manganese (Mn)/zinc (Zn) atomic weight ratio with respect to the magnetic core formed with a ferrite composition according to one embodiment.

FIG. 4 is a graph showing a change in core loss depending on the amount of non-magnetic additive added to a magnetic core of sample 9 formed with a ferrite composition according to one embodiment.

FIG. 5 is a graph showing a change in permeability depending on the amount of non-magnetic additive added to a magnetic core of sample 9 formed with a ferrite composition according to one embodiment.

FIG. 6 is a graph showing the measured coercivity and core loss of sample 15 formed with the ferrite composition according to one embodiment.

FIG. 7 is a graph showing comparison in the core loss between the magnetic core of sample 15 formed with the ferrite composition according to one embodiment, and commercial core parts.

### BEST MODE

Hereinafter, various modifications and implementations of the present disclosure are possible and will be described in detail with reference to the annexed drawings. However, it should be understood that the present disclosure is not limited to specific embodiments and a variety of modifications, equivalents and alterations are possible without departing from the ideas and scope of the present disclosure.

It will be understood that, although terms including ordinal numbers such as “second” or “first” may be used herein to describe various elements, these elements should not be construed as being limited by these terms which are used only to distinguish one element from another. For example, within the scope defined by the disclosure, a second element may be referred to as a first element, and similarly, a first element may be referred to as a second element. The term “and/or” includes a combination of a plurality of the related described items or any one of the plurality of related described items.

It will be understood that when an element is referred to as being “bound” or “connected” to another element, it may be directly bound or connected to the element, or one or more intervening elements may also be present therebetween. On the other hand, it will be understood that when an element is referred to as being “directly bound” or “directly connected” to another element, there is no intervening element therebetween.

It will be understood that when an element such as a layer (film), region, pattern or structure is referred to as being “on” or “under” another element such as a substrate, layer (film), region, pad or pattern, it may be directly on/under the element, or one or more intervening elements may also be present. When an element is referred to as being “on” or “under”, “under the element” as well as “on the element” can be included based on the element. In addition, in the drawings, the thickness or size of a layer (film), region, pattern or structure may be exaggerated for clarity and convenience, and may thus be different from the actual thickness or size thereof.

In addition, terms used herein are provided only for illustration of certain embodiments and should not be construed as limiting the scope of the disclosure. Singular forms are intended to include plural forms as well, unless the context clearly indicates otherwise. It will be further understood that the terms “comprises” and/or “has” used herein specify the presence of stated features, numbers, steps, operations, elements, components or combinations thereof, but do not preclude the presence or addition of one or more other features, numbers, steps, operations, elements, components, or combinations thereof.

Unless defined otherwise, all terms used herein including technical or scientific terms have the same meanings as generally understood by those skilled in the art. In addition, terms identical to those defined in generally used dictionaries should be interpreted as having meanings identical to contextual meanings in the related art and are not to be interpreted as having abnormally or excessively formal meanings unless they are definitely defined herein.

An embodiment provides a ferrite composition that has an optimized design to induce a lowest loss and minimize a loss change depending on a temperature change, in order to form a magnetic product that maintains low loss characteristics.

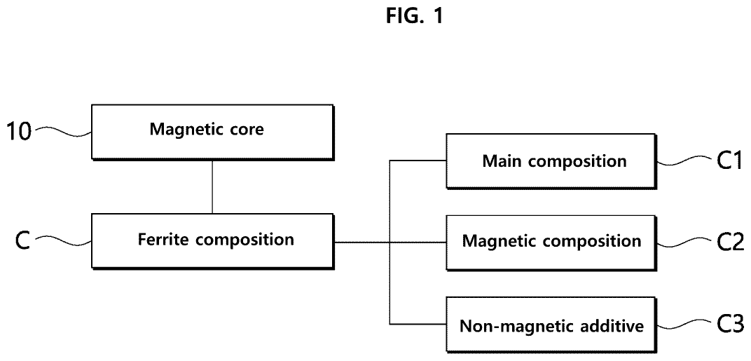

FIG. 1 is a block diagram illustrating the configuration of a ferrite composition and a magnetic core containing the same according to one embodiment.

Referring to FIG. 1, a ferrite composition C according to one embodiment includes a main composition C1, a magnetic ion agent C2, and a non-magnetic additive C3. In this embodiment, a magnetic core 10 will be described as an example of a magnetic product formed using the ferrite composition C.

The main composition C1 may include a manganese (Mn) component, a zinc (Zn) component, an iron (Fe) component, and a cobalt (Co) component.

The magnetic ion agent C2 may include a compound of iron (Fe) and cobalt (Co) that form magnetic ions. The magnetic ion agent C2 may impart magnetic ions such as Fe²⁺, Fe³⁺, and Co²⁺ to the magnetic core 10.

The non-magnetic additive C3 may minimize the change in coercivity depending on temperature change. The non-magnetic additive C3 may include at least one of calcium oxide (CaO), niobium oxide (Nb₂O₅), or a mixture thereof.

The ferrite composition C constituting the magnetic core 10 according to one embodiment may induce the lowest loss of the magnetic core 10 based on a composition design to control the contents of the magnetic ion agent C2 and the main composition C1.

The induction of the lowest loss (P_{cv}) may form a magnetic core 10 with low coercivity by optimizing the content of the magnetic ion agent C2. The coercivity may affect the hysteresis loss. In addition, the coercivity may be affected by the magnetic ion agent C2.

In order to form a magnetic core 10 having low coercivity, seven starting materials were prepared under Conditions 1 to 7 as shown in Table 1 below.

TABLE 1

| | | Condition | Condition | Condition | Condition | Condition | Condition | Condition |
|---|---|---|---|---|---|---|---|---|
| Composition | | 1(A) | 2(B) | 3(C) | 4(D) | 5(E) | 6(F) | 7(G) |
| Atomic ratio | Mn | 0.67 | 0.69 | 0.69 | 0.70 | 0.71 | 0.72 | 0.73 |
| of main | Zn | 0.19 | 0.19 | 0.20 | 0.20 | 0.20 | 0.20 | 0.20 |
| composition | Fe | 2.13 | 2.11 | 2.09 | 2.08 | 2.07 | 2.06 | 2.05 |
| | Co | 0.015 | | | | | | |
| Atomic ratio | Fe + Co | 2.14 | 2.13 | 2.11 | 2.10 | 2.09 | 2.07 | 2.06 |
| of magnetic | | | | | | | | |
| ion agent | | | | | | | | |
| Content ratio | MnO | 20.38 | 20.87 | 20.87 | 21.35 | 21.60 | 21.84 | 22.33 |
| of raw | ZnO | 6.53 | 6.53 | 7.07 | 7.08 | 7.08 | 7.08 | 7.09 |
| material | Fe₂O₃ | 72.56 | 72.07 | 71.53 | 71.03 | 70.79 | 70.54 | 70.05 |
| (wt %) | Co₃O₄ | 0.54 | 0.54 | 0.54 | 0.54 | 0.54 | 0.54 | 0.54 |

Table 1 shows the atomic weight ratio and content ratio of starting materials for preparing magnetic core samples. The starting materials prepared as shown in Table 1 exclude the non-magnetic additive C3.

As shown in Table 1, the atomic weight ratio of cobalt (Co), which is a component of the main composition C1, may be added in the range of 0.010 to 0.020. Here, the atomic weight ratio and content ratio of manganese (Mn), zinc (Zn), and iron (Fe), which constitute the main composition C1, were adjusted under the condition that the atomic weight ratio of cobalt (Co) was fixed to 0.015. In addition, the atomic weight ratio of the compound of iron (Fe) and cobalt (Co) (Fe+Co) as a magnetic ion agent C2 was set within a range of from 2.06 to 2.14.

The contents of the main composition C1 and the magnetic ion agent C2 may be analyzed using WD-XRF (wavelength dispersive-X-ray fluorescence) equipment as follows.

TABLE 2

| | | Sample | Sample | Sample | Sample | Sample | Sample | Sample |
|---|---|---|---|---|---|---|---|---|
| Composition | | 1(A) | 2(B) | 3(C) | 4(D) | 5(E) | 6(F) | 7(G) |
| Content ratio | MnO | 19.54 | 19.69 | 19.81 | 20.34 | 19.49 | 20.69 | 21.34 |
| of raw | ZnO | 6.70 | 6.87 | 7.35 | 7.04 | 6.91 | 7.31 | 7.10 |
| material | Fe₂O₃ | 73.22 | 72.00 | 72.33 | 72.13 | 73.08 | 71.46 | 71.05 |
| (wt %) | Co₃O₄ | 0.54 | 0.54 | 0.52 | 0.49 | 0.52 | 0.54 | 0.51 |

As can be seen from the results of WD-XRF analysis in Table 2, the content of each raw material is the same as the content of the ferrite composition C as in Table 1, but the content of the magnetic core 10 is changed due to the reason such as powder loss, i.e. ignition loss in the process of producing the magnetic core 10 using the ferrite composition C.

Table 2 shows the content ratios of raw materials constituting magnetic core 10 samples produced with the ferrite composition C under conditions 1 to 7 in Table 1.

The manganese (Mn), zinc (Zn), iron (Fe), and cobalt (Co) that constitute the main composition C1 were oxide form raw materials. In addition, the magnetic ion agent C2 may also be prepared from iron oxide (Fe₂O₃) and cobalt oxide (Co₃O₄).

For example, samples 1 to 7 of the magnetic core 10 formed with the raw material content ratio of the ferrite composition C shown in Table 1 contain 19.54 wt % to 21.34 wt % of manganese oxide (MnO), 6.70 wt % to 7.35 wt % of zinc oxide (ZnO), 71.05 wt % to 73.22 wt % of iron oxide (Fe₂O₃), and 0.49 wt % to 0.54 wt % of cobalt oxide (Co₃O₄).

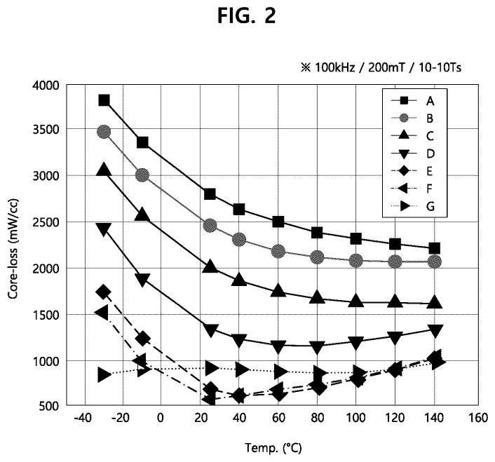

FIG. 2 is a graph showing a core loss change as a function of temperature change in the atomic ratio of the magnetic ion agent (Fe+Co) with respect to each of the magnetic cores formed with the ferrite composition according to one embodiment.

FIG. 2 is a graph showing the measured lowest loss of magnetic core 10 samples prepared under seven conditions in which, in the main composition C1, an atomic ratio of a manganese (Mn) component to a zinc (Zn) component is set to 3.35 to 3.65, and an atomic ratio of a compound (Fe+Co) of iron (Fe) and cobalt (Co) is set to 2.06 to 2.14.

Here, magnetic core 10 samples 1 to 7 of Table 2 formed under conditions 1 to 7 shown in Table 1 were wound 10 times with a primary coil and 10 times with a secondary coil, and the core loss of the magnetic core 10 samples wound with the primary and secondary coils was measured at a maximum magnetic flux density of 200 mT and at a frequency of 100 kHz.

As can be seen from FIG. 2, the lowest loss of samples 1 to 6 decrease from 2,214 mW/cc to 589 mW/cc at −30° C. to 140° C. Sample 6 has a lowest loss of 589 mW/cc at room temperature (27° C.) and sample 1 has a lowest loss of 2,214 mW/cc at 140° C.

Among these samples, samples 4 to 6 have a lowest core loss which is decreased compared to samples 1 to 3 as the atomic ratio of the iron (Fe) and cobalt (Co) compound (Fe+Co) decreases.

Specifically, the loss of samples 4 to 6 prepared with an atomic ratio of the iron (Fe) and cobalt (Co) compound (Fe+Co) of 2.07 to 2.10 decreased compared to samples 1 to 3 prepared with an atomic ratio of the iron (Fe) and cobalt (Co) compound (Fe+Co) of 2.11 to 2.14.

On the other hand, in Table 2, sample 7 has an overall low core loss, but is not considered to be useful because it is difficult for sample 7 to have a lowest loss due to the difference between the graph of the change in core loss and the graph of the change in coercivity.

Therefore, the core loss was found to be lower when the atomic ratio of the compound (Fe+Co) of iron (Fe) and cobalt (Co), which is a magnetic ion agent C2, falls within the range of 2.07 to 2.10.

This is because the coercivity of the samples may be minimized by controlling the content of the magnetic ion agent C2. In other words, the level of the induced coercivity may be obtained by the width of the hysteresis loop and the increase in core loss (Pcv) may be sensitively changed by changes in hysteresis loss (Phv) and eddy current loss (Pev).

Therefore, it can be seen that the magnetic ions of Fe²⁺, Fe³⁺, and Co²⁺ of the magnetic ion agent C2 may minimize the coercivity of the magnetic core 10. In other words, the cobalt (Co) component may replace an iron ion (Fe²⁺), thus improving the temperature dependency and contributing to the control of magnetic anisotropy.

Therefore, the ferrite composition C and the magnetic core 10 containing the same according to one embodiment may provide similar coercivity change and core loss change behaviors depending on the temperature and may lower the loss of the magnetic core 10 and minimize the change depending on the temperature through control of the content of the magnetic ion agent C2.

Meanwhile, the ferrite composition C and the magnetic core 10 containing the same according to one embodiment may also minimize core loss through the mixing ratio of iron (Fe) and cobalt (Co) components.

The optimal mixing ratio of iron (Fe) and cobalt (Co) to minimize core loss of the ferrite composition C and the magnetic core 10 containing the same according to one embodiment is shown in Table 3 below.

TABLE 3

| | | Condition | Condition | Condition | Condition | Condition |
|---|---|---|---|---|---|---|
| Composition | | 8(H) | 9(I) | 10(J) | 11(K) | 12(L) |
| Atomic ratio | Mn | 0.76 | 0.74 | 0.72 | 0.74 | 0.73 |
| of main | Zn | 0.15 | 0.16 | 0.18 | 0.17 | 0.18 |
| composition | Fe | 2.08 | 2.08 | 2.08 | 2.07 | 2.07 |
| | Co | 0.01 | 0.01 | 0.01 | 0.01 | 0.01 |
| | Mn/Zn | 5.00 | 4.50 | 4.00 | 4.50 | 4.00 |
| Atomic ratio | Fe + Co | 2.10 | | | 2.08 | |
| of magnetic | | | | | | |
| ion agent | | | | | | |
| Content | MnO | 22.99 | 22.56 | 22.04 | 22.76 | 22.23 |
| ratio of raw | ZnO | 5.27 | 5.75 | 6.32 | 5.80 | 6.38 |
| material | Fe₂O₃ | 71.40 | 71.36 | 71.30 | 71.04 | 70.99 |
| (wt %) | Co₃O₄ | 0.34 | 0.34 | 0.34 | 0.40 | 0.40 |

As shown in Table 3, the manganese (Mn) component in the ferrite composition C is added in an atomic ratio of 0.73 to 0.76 and the manganese (Mn) component is preferably added in an atomic ratio of 0.74 to 0.76.

The zinc (Zn) component in the ferrite composition C is added in an atomic ratio of 0.15 to 0.18 and the zinc (Zn) component is preferably added in an atomic ratio of 0.15 to 0.16.

The iron (Fe) component in the ferrite composition C is added in an atomic ratio of 2.07 to 2.08 and the iron (Fe) component is preferably added in an atomic ratio of 2.08.

The cobalt (Co) component in the ferrite composition C is added in an atomic ratio of 0.01.

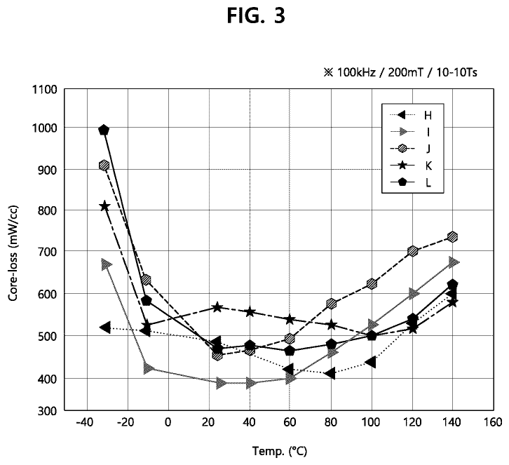

In FIG. 3, the atomic ratios of the magnetic ion agent C2 of samples 4 and 5, among the samples 4 to 6 having a lowest loss, are set to 2.10 and 2.08, and the atomic ratio of the cobalt (Co) component based on the total atomic ratio of the main composition C1 is set to 0.01.

In addition, the atomic ratio of manganese (Mn) to zinc (Zn) is set to the range of 4.0 to 5.0.

TABLE 4

| | | Sample | Sample | Sample | Sample | Sample |
|---|---|---|---|---|---|---|
| Composition | | 8(H) | 9(I) | 10(J) | 11(K) | 12 (L) |
| Content | MnO | 21.92 | 21.45 | 21.06 | 20.38 | 21.21 |
| ratio of raw | ZnO | 5.55 | 5.98 | 6.57 | 5.72 | 6.62 |
| material | Fe₂O₃ | 72.18 | 72.22 | 72.03 | 73.55 | 71.78 |
| (wt %) | Co₃O₄ | 0.35 | 0.35 | 0.35 | 0.36 | 0.40 |

Table 4 shows the results of WD-XRF analysis of the raw material content ratios of magnetic core 10 samples formed with the ferrite composition C under conditions 8 to 12 of the atomic weight ratio and raw material content ratio shown in Table 3.

As shown in Table 4, the manganese (Mn), zinc (Zn), iron (Fe), and cobalt (Co) components constituting the main composition C1 are used in the form of oxides, the iron oxide (Fe₂O₃) and cobalt oxide (Co₃O₄) constituting the magnetic ion agent C2 are used in the form of oxides, and the optimized ratio of the iron (Fe) and cobalt (Co) compound (Fe+Co) is measured.

For example, magnetic core 10 samples 8 to 12 formed with the raw material content ratio of the ferrite composition C shown in Table 3 contain 20.38 wt % to 21.92 wt % of manganese oxide (MnO), 5.55 wt % to 6.62 wt % of zinc oxide (ZnO), 71.78 wt % to 73.55 wt % of iron oxide (Fe₂O₃), and 0.35 wt % to 0.36 wt % of cobalt oxide (Co₃O₄).

FIG. 3 is a graph showing a core loss change depending on temperature change in the manganese (Mn)/zinc (Zn) atomic weight ratio with respect to the magnetic core formed with a ferrite composition according to one embodiment.

FIG. 3 is a graph showing the measured lowest loss of a prepared magnetic core 10 sample in which an atomic ratio of a compound (Fe+Co) of iron (Fe) and cobalt (Co) constituting the magnetic ion agent C2 in the main composition C1 is set to 2.10 to 2.08 and an atomic ratio of a manganese (Mn) component to a zinc (Zn) component is set to 4.0 to 5.0.

Here, as shown in the graph of FIG. 3, magnetic core 10 samples produced shown in FIG. 2 are wound 10 times with a primary coil and 10 times with a secondary coil, and the core loss of the magnetic core 10 samples wound with the primary and secondary coils is measured at a maximum magnetic flux density of 200 mT and at a frequency of 100 kHz.

As can be seen from FIG. 3, Samples 8 to 12 have a lowest loss of 550 mW/cc to 390 mW/cc at −30° C. to 140° C. In particular, sample 9 has a lowest loss of 419 mW/cc at 80° C. and sample 8 has a lowest loss of 390 mW/cc at 40° C.

Among these samples, samples 8 and 9 have a lowest core loss under the condition where the atomic ratio of the iron (Fe) and cobalt (Co) compound (Fe+Co) is 2.10 and the lowest core loss is lower than that under the condition where the atomic ratio of the iron (Fe) and cobalt (Co) compound (Fe+Co) is 2.08.

Therefore, the lowest core loss is obtained when the atomic ratio of the compound (Fe+Co) of iron (Fe) and cobalt (Co) falls within the range of 2.08 to 2.10.

In addition, it can be seen that the lowest loss is obtained when the atomic ratio of the manganese (Mn) component to the zinc (Zn) component is 4.5 to 5.0. In particular, it can be seen that the lowest loss is lower at 40° C. when the atomic ratio of the manganese (Mn) component to the zinc (Zn) component is 4.5.

This is because control of the content of the iron (Fe) and cobalt (Co) compound (Fe+Co) as well as control of the atomic ratio of the manganese (Mn) component to the zinc (Zn) component can minimize the change in the hysteresis loss depending on temperature change, thereby minimizing the change in the core loss pattern.

Therefore, the ferrite composition C and the magnetic core 10 containing the same according to one embodiment may provide similar coercivity change behaviors and core loss change behaviors depending on the temperature and may lower the loss of the magnetic core 10 and minimize the change depending on the temperature through control of the content of the iron (Fe) and cobalt (Co) compound (Fe+Co), and control of the atomic ratio of manganese (Mn) to zinc (Zn) components.

Furthermore, by adding a non-magnetic additive C3 to sample 9, the coercivity can be minimized to induce the lowest loss.

The optimal conditions for minimizing the coercivity through the non-magnetic additive C3 to induce the lowest loss are as shown in Table 5 below.

TABLE 5

| | | Condition | Condition | Condition | Condition | Condition | Condition |
|---|---|---|---|---|---|---|---|
| Composition | | 13 (I-1) | 14 (I-2) | 15 (I-3) | 16 (I-4) | 17 (I-5) | 18 (I-6) |
| Atomic ratio of | Mn | 0.74 to 0.76 | | | | | |
| main composition | Zn | 0.15 to 0.17 | | | | | |
| | Fe | 2.08 to 2.09 | | | | | |
| | Co | 0.005 to 0.010 | | | | | |
| | Mn/Zn | 4.40 to 4.60 | | | | | |
| Atomic ratio of | Fe + Co | 2.08 to 2.10 | | | | | |
| magnetic ion agent | | | | | | | |
| Content ratio of | MnO | 22 to 23 | | | | | |
| raw material | ZnO | 5 to 6 | | | | | |
| (wt %) | Fe₂O₃ | 71 to 72 | | | | | |
| | Co₃O₄ | 0.3 to 0.4 | | | | | |
| Content of non- | CaO | 400 ppm | 400 ppm | 400 ppm | 400 ppm | 400 ppm | 400 ppm |
| magnetic additive | | to | to | to | to | to | to |
| | | 600 ppm | 600 ppm | 600 ppm | 600 ppm | 600 ppm | 600 ppm |
| | Nb₂O₅ | 400 ppm | 300 ppm | 200 ppm | 100 ppm | 50 ppm | 100 ppm |
| | | to | to | to | to | to | to |
| | | 600 ppm | 500 ppm | 400 ppm | 300 ppm | 150 ppm | 300 ppm |

Table 5 shows the content ratio of the non-magnetic additive C3 based on the atomic ratio of sample 9 among magnetic core samples. As shown in Table 5, calcium oxide (CaO) and niobium oxide (Nb₂O₅) are added as non-magnetic additives (C3) to the magnetic core 10 based on the atomic ratio of sample 9. In this embodiment, the non-magnetic additive C3 includes both calcium oxide (CaO) and niobium oxide (Nb₂O₅), but this is not limited thereto and the non-magnetic additive C3 may include at least one of calcium oxide (CaO) or niobium oxide (Nb₂O₅).

The non-magnetic additive C3 may level down the core loss depending on temperature of the magnetic core 10. Accordingly, the content of the non-magnetic additive C3 is controlled and the resulting changes are measured.

At this time, the ratio of calcium oxide (CaO) that is added may be set to 400 ppm to 600 ppm.

TABLE 6

| | | Sample 13 | Sample 14 | Sample 15 | Sample 16 | Sample 17 | Sample 18 |
|---|---|---|---|---|---|---|---|
| Composition | | (I-1) | (I-2) | (I-3) | (I-4) | (I-5) | (I-6) |
| Content ratio of | MnO | 21.44 | 21.49 | 21.29 | 21.32 | 21.43 | 21.57 |
| raw material | ZnO | 5.98 | 5.86 | 5.76 | 6.06 | 5.89 | 6.01 |
| (wt %) | Fe₂O₃ | 72.26 | 72.33 | 72.61 | 72.29 | 72.33 | 72.09 |
| | Co₃O₄ | 0.32 | 0.33 | 0.34 | 0.32 | 0.34 | 0.33 |
| Content of non- | CaO | 400 ppm to | 0 ppm to | 0 ppm to | 0 ppm to | 0 ppm to | 0 ppm to |
| magnetic | | 600 ppm | 600 ppm | 600 ppm | 600 ppm | 600 ppm | 600 ppm |
| additive | Nb₂O₅ | 00 ppm to | 0 ppm to | 0 ppm to | 0 ppm to | 0 ppm to | 0 ppm to |
| | | 600 ppm | 500 ppm | 400 ppm | 300 ppm | 150 ppm | 300 ppm |

Table 6 shows the results of WD-XRF analysis of the raw material content ratios of magnetic core 10 samples formed with the ferrite composition C under conditions 13 to 18 of the atomic weight ratio and raw material content ratio shown in Table 5. Here, Table 6 shows the magnetic core samples formed by adding niobium oxide (Nb₂O₅) in an amount from 50 ppm to 600 ppm, as in Table 5, regarding contents of the main composition C1 and the magnetic ion agent C2 of sample 9 in Table 4.

As shown in Table 5, niobium oxide (Nb₂O₅) as the non-magnetic additive C3 is adjusted from 50 ppm to 600 ppm under change conditions. On the other hand, as shown in Table 6, the content of the non-magnetic additive C3 may be different from the content of the final part due to powder loss, i.e. ignition loss, during the process of manufacturing the samples.

Samples 13 to 18 of the magnetic core 10 formed with the raw material content ratio of the ferrite composition C shown in Table 6 contain 21.29 wt % to 21.57 wt % of manganese oxide (MnO), 5.76 wt % to 6.06 wt % of zinc oxide (ZnO), 72.09 wt % to 72.33 wt % of iron oxide (Fe₂O₃) and 0.32 wt % to 0.34 wt % of cobalt oxide (Co₃O₄).

In addition, the non-magnetic additive C3 contained 40 ppm to 600 ppm of calcium oxide (CaO) and 50 ppm to 600 ppm of niobium oxide (Nb₂O₅).

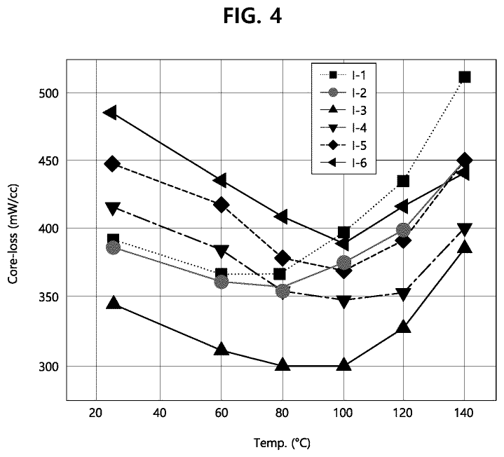

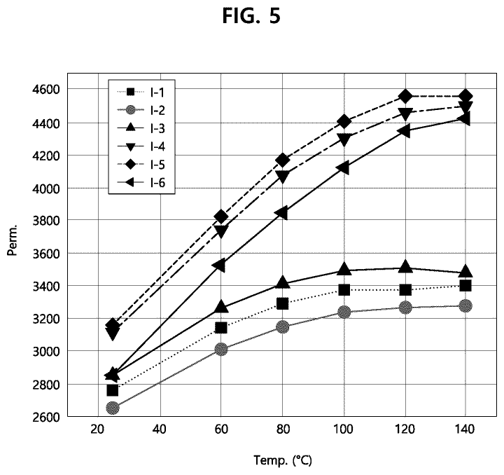

FIG. 4 is a graph showing a change in core loss depending on the amount of non-magnetic additive added to the magnetic core of sample 9 formed with a ferrite composition according to one embodiment and FIG. 5 is a graph showing a change in permeability depending on the amount of non-magnetic additive added to a magnetic core of sample 9 formed with a ferrite composition according to one embodiment.

Here, FIG. 4 and FIG. 5 show a change in core loss depending on temperature change and a change in permeability depending on temperature change, respectively.

Here, magnetic core 10 samples shown in Table 6 formed from raw materials shown in Table 5 are wound 10 times with a primary coil and 10 times with a secondary coil, the core loss of the magnetic core 10 samples wound with the primary and secondary coils is measured at a maximum magnetic flux density of 200 mT and at a frequency of 100 kHz, and the results are shown in the graphs of FIGS. 4 and 5.

FIGS. 4 and 5 show core loss and permeability at 25° C. to 140° C., respectively.

Referring to FIG. 4, sample 13 has a lowest loss of 363 mW/cc at 80° C. and a highest loss of 506 mW/cc at 140° C. Sample 14 has a lowest loss of 354 mW/cc at 80° C. and a highest loss of 450 mW/cc at 140° C. Sample 15 has a lowest loss of 296 mW/cc at 80° C. and a highest loss of 379 mW/cc at 140° C. Sample 16 has a lowest loss of 355 mW/cc at 80° C. and a highest loss of 396 mW/cc at 140° C. Sample 17 has a lowest loss of 368 mW/cc at 100° C. and a highest loss of 451 mW/cc at 140° C. Sample 18 has a lowest loss of 368 mW/cc at 100° C. and a highest loss of 440 mW/cc at 140° C.

As such, the core loss measured at each temperature is summarized in Table 7 below.

TABLE 7

| | | | | | | | | | ΔP_{cv} |
|---|---|---|---|---|---|---|---|---|---|
| | Pcv (mW/cc) | | | | | | Min. | Max. | (Max. − |
| Composition | 25° C. | 0° C. | 80° C. | 100° C. | 120° C. | 140° C. | P_{cv} | P_{cv} | Min.) |
| Sample 13 | 390 | 364 | 363 | 395 | 429 | 506 | 363 | 506 | 143 |
| (I-1) | | | | | | | | | |
| Sample 14 | 385 | 359 | 354 | 370 | 398 | 450 | 354 | 450 | 96 |
| (I-2) | | | | | | | | | |
| Sample 15 | 344 | 310 | 296 | 296 | 323 | 379 | 296 | 379 | 83 |
| (I-3) | | | | | | | | | |
| Sample 16 | 415 | 383 | 355 | 346 | 351 | 396 | 355 | 415 | 60 |
| (I-4) | | | | | | | | | |
| Sample 17 | 447 | 416 | 377 | 368 | 390 | 451 | 368 | 451 | 83 |
| (I-5) | | | | | | | | | |
| Sample 18 | 485 | 436 | 408 | 386 | 416 | 440 | 386 | 485 | 99 |
| (I-6) | | | | | | | | | |

Referring to Table 7, the loss change (ΔP_{cv}), which indicates the difference between the highest loss and the lowest loss, is 60 mW/cc to 143 mW/cc. Sample 13 has a loss change of 143 mW/cc, sample 14 has a loss change of 96 mW/cc, sample 15 has a loss change of 83 mW/cc, sample 16 has a loss change of 60 mW/cc, sample 17 has a loss change of 83 mW/cc, and sample 18 has a loss change of 99 mW/cc.

The loss change, which indicates the difference between the highest loss and the lowest loss, is a parameter of a loss increase. As the loss change decreases, the loss increase decreases. The magnetic core 10 having a loss change of 100 mW/cc or less may be considered to have a low loss increase.

As shown in Table 7, all of samples 14 to 18 excluding sample 13 have a loss change of 100 mW/cc or less, indicating a small loss increase. On the other hand, sample 13 has a loss change of 143 mW/cc, which is more than 100 mW/cc, indicating that the loss increase was high compared to other samples. Therefore, the magnetic core having 50 ppm to 500 ppm of niobium oxide (Nb₂O₅) has a small loss change.

Therefore, regarding the ferrite composition C and the magnetic core 10 containing the same according to one embodiment, samples 14 to 18 have a loss change of 60 mW/cc to 99 mW/cc, that is, have a loss change less than 100 mW/cc, within a temperature range of room temperature (25° C.) to 140° C., and thus have a minimized loss increase.

Referring to FIG. 5, the ferrite composition C and the magnetic core 10 containing the same according to one embodiment have a permeability of 2,651 to 4,540 in a temperature range from room temperature (25° C.) to 140° C. At this time, the permeability at room temperature (25° C.) may be defined as an initial permeability.

Permeability data measured within a temperature range of room temperature (25° C.) to 140° C. of the ferrite composition and the magnetic core 10 containing the same according to one embodiment are summarized in Table 8 below.

TABLE 8

| | Permeability (mW/cc) | | | | | |
|---|---|---|---|---|---|---|
| Composition | 25° C. | 60° C. | 80° C. | 100° C. | 120° C. | 140° C. |
| Sample 13 | 2750 | 2651 | 2855 | 3099 | 3153 | 2851 |
| (I-1) | | | | | | |
| Sample 14 | 3131 | 3003 | 3256 | 3741 | 3810 | 3520 |
| (I-2) | | | | | | |
| Sample 15 | 3279 | 3139 | 3406 | 4058 | 4151 | 3830 |
| (I-3) | | | | | | |
| Sample 16 | 3360 | 3227 | 3485 | 4284 | 4387 | 4105 |
| (I-4) | | | | | | |
| Sample 17 | 3362 | 3259 | 3502 | 4440 | 4535 | 4326 |
| (I-5) | | | | | | |
| Sample 18 | 3380 | 3264 | 3470 | 4473 | 4540 | 4400 |
| (I-6) | | | | | | |

Referring to Table 8, samples 14 to 18, which have minimized loss change in Table 7 have permeability of 3,003 to 4,540, and sample 13 has permeability of 2,651 to 3,153. In other words, samples 14 to 18 have higher permeability than that of sample 13.

Therefore, regarding the ferrite composition and the magnetic core 10 containing the same according to one embodiment, samples 14 to 18 have a minimized loss increase of 60 mW/cc to 99 mW/cc in the temperature range of room temperature (25° C.) to 140° C., and have high permeability of 3,003 to 4,540.

The example in which core loss is minimized based on the content ratio of the magnetic ion agent C2, the content ratio of manganese (Mn) to zinc (Zn), and the non-magnetic additive C3 is summarized in Table 9.

TABLE 9

Content ratio

| Material | Minimum | Maximum | Range | Unit |
|---|---|---|---|---|
| MnO | 21.29 | 21.57 | 21.2 to 21.6 | wt % |
| ZnO | 5.76 | 6.06 | 5.7 to 6.1 | |
| Fe₂O₃ | 72.09 | 72.61 | 72 to 72.7 | |
| Co₃O₄ | 0.32 | 0.34 | 0.3 to 0.4 | |
| CaO | 400 | 600 | 400 to 600 | ppm |
| Nb₂O₅ | 50 | 600 | 50 to 600 | |

It can be seen that, when manganese oxide (MnO) is contained in an amount of 21.2 wt % to 21.6 wt %, zinc oxide (ZnO) is contained in an amount of 5.7 wt % to 6.1 wt %, iron oxide (Fe₂O₃) is contained in an amount of 72 wt % to 72.7 wt %, cobalt oxide (Co₃O₄) is contained in an amount of 0.3 wt % to 0.4 wt %, calcium oxide (CaO) is contained in an amount of 400 ppm to 600 ppmm as a non-magnetic additive C3, and niobium oxide (Nb₂O₅) is contained in an amount of 50 ppm to 600 ppm, the lowest loss of the magnetic core is minimized and the loss increase depending on temperature change is minimized.

Therefore, the magnetic core 10 formed with the ferrite composition C according to one embodiment can minimize the loss of the magnetic core 10 and minimize the loss increase depending on temperature change by optimizing the amount of non-magnetic additive C3 added.

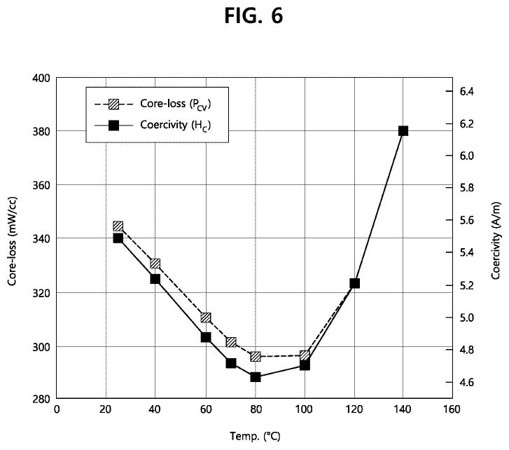

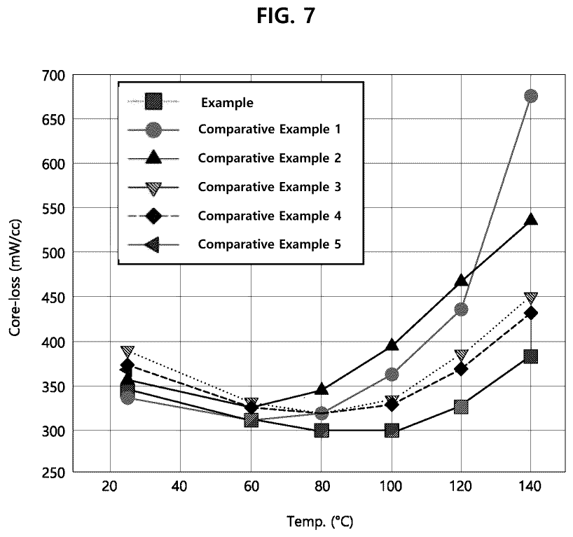

FIG. 6 is a graph showing the measured coercivity and core loss of sample 15 formed with the ferrite composition according to one embodiment and FIG. 7 is a graph showing comparison in the core loss between the magnetic core of sample 15 formed with the ferrite composition according to one embodiment, and commercial core parts.

As can be seen from FIG. 6, the change pattern of the core loss depending on temperature and the change pattern of the coercivity of the magnetic core 10 formed with the ferrite composition according to one embodiment are consistent with each other.

The coercivity of the magnetic core 10 formed with the ferrite composition according to one embodiment may be affected by the content ratio of the magnetic ion agent (Fe²⁺, Fe³⁺, and Co²⁺) and the size of the magnetic anisotropy depending on the temperature, as in the compositions of FIGS. 2 to 5 described above. This coercivity may affect the hysteresis loss.

Therefore, the magnetic core 10 formed with the ferrite composition may lower the coercivity by optimizing the content of the atomic weight ratio of the magnetic ion agent (Fe+Co) and the atomic weight ratio of manganese (Mn)/zinc (Zn). That is, the lowest loss of the magnetic core 10 may be obtained through the ferrite composition C designed to have low coercivity.

In addition, the magnetic core 10 formed with the ferrite composition according to one embodiment can minimize the change in coercivity depending on temperature change while reducing the minimum loss based on control of the content of the non-magnetic additive C3. Magnetic anisotropy has a dependency on temperature and the degree of magnetic anisotropy may change as temperature changes.

Therefore, controlling the content of the non-magnetic additive C3 may affect controlling a loss change (increase) depending on temperature change.

For example, the magnetic core 10 of sample 15 formed with the ferrite composition according to one embodiment has a core loss within a range from 296 mW/cc to 379 mW/cc at 25° C. to 140° C., a lowest core loss of 296 mW/cc at 80° C. and 100° C., and a highest core loss of 379 mW/cc at 140° C.

In addition, the magnetic core 10 of sample 15 formed with the ferrite composition according to one embodiment has a coercivity within a range from 4.6 A/m to 6.2 A/m at 25° C. to 140° C., and a lowest coercivity of 4.6 A/m at 80° C., and a highest coercivity of 6.2 A/m at 140° C.

The change pattern of the coercivity and the change pattern of the core loss as shown in the graph of FIG. 6 are summarized in Table 10 below.

TABLE 10

| Temperature | 25° C. | 40° C. | 60° C. | 70° C. | 80° C. | 100° C. | 120° C. | 140° C. |
|---|---|---|---|---|---|---|---|---|
| Coercivity (A/m)) | 5.5 | 5.2 | 4.9 | 4.7 | 4.6 | 4.7 | 5.2 | 6.2 |
| Change in | | −4.6% | −6.7% | −3.3% | −1.9% | 1.4% | 10.9% | 18.2% |
| Coercivity as | | | | | | | | |
| function of | | | | | | | | |
| temperature | | | | | | | | |
| Core loss (mW/cc) | 344 | 330 | 310 | 301 | 296 | 296 | 323 | 379 |
| Change in core loss | | −4.2% | −5.9% | −2.9% | −1.9% | 0.1% | 9.0% | 17.4% |
| as function of | | | | | | | | |
| temperature | | | | | | | | |

As shown in Table 10, the magnetic core 10 formed with the ferrite composition according to one embodiment has a core loss change rate in the range of −6% to 18%. For example, the magnetic core 10 has a lowest core loss change rate of −5.9% at 80° C. and a highest core loss change rate of 17.4% at 140° C.

In addition, the magnetic core 10 formed with the ferrite composition according to one embodiment has a coercivity change rate in the range of −7% to 20%. For example, the magnetic core 10 has a lowest coercivity change rate of −6.7% at 60° C. and a highest coercivity change rate of 18.2% at 140° C.

As can be seen from FIG. 6 showing the core loss change rate and the coercivity change rate, the pattern of the core loss change rate is similar to the pattern of the coercivity change rate.

Therefore, it can be seen that the core loss of the magnetic core 10 formed with the ferrite composition according to one embodiment greatly depends on the hysteresis loss under the operation conditions described above in FIGS. 2 to 5. It can be seen that, when the main factors of the composition design are designed to correspond to the purpose, for example, the ferrite composition is optimized such that the coercivity is lowered as much as possible and the rate of change thereof is not large, the change in the hysteresis loss depending on the temperature change is minimized, thereby implementing a material that has a low core loss of the magnetic core 10 and has a small change depending on the temperature.

Referring to FIG. 7, the magnetic core 10 formed with the ferrite composition according to one embodiment has a lower core loss compared to Comparative Examples.

The magnetic core 10 according to embodiment herein has a measured core loss of sample 15.

When comparing Comparative Examples 1 to 5 with the embodiments, the core loss of the embodiment is lowest. Furthermore, as shown in FIG. 6, since the embodiment exhibits a core loss change rate pattern similar to a coercivity change rate, the lowest loss of the magnetic core is minimized and the loss increase rate depending on temperature change is minimized by optimizing the composition of the magnetic ion agent, the composition of the main composition, and the amount of non-magnetic additive added.

The description of each of the embodiments may be applied to other embodiments as long as the contents of embodiments do not conflict with each other.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### INDUSTRIAL APPLICABILITY

The ferrite composition and the magnetic core containing the same according to the present embodiment may be used for power supplies of various electronic products.

1. A magnetic core comprising:
a main composition comprising a manganese (Mn) component having an atomic ratio of 0.74 to 0.76, a zinc (Zn) component having an atomic ratio of 0.15 to 0.17, an iron (Fe) component having an atomic ratio of 2.08 to 2.09, and a cobalt (Co) component having an atomic ratio of 0.005 to 0.010;
a magnetic ion agent; and
a non-magnetic additive,
wherein the magnetic core has a core loss of 300 mW/cc or less at 80 to 100° C., at a frequency of 100 kHz and at a maximum magnetic flux density of 200 mT.

2. The magnetic core according to claim 1, wherein the magnetic core has a coercivity change rate of 7% to 20% at 25° C. to 140° C.

3. The magnetic core according to claim 1, wherein a change rate of the core loss is-6% to 18% at 25° C. to 140° C.

4. The magnetic core according to claim 1, wherein a change in the core loss is less than 100 mW/cc at 25° C. to 140° C.

5. The magnetic core according to claim 4, wherein the change in the core loss ranges from 60 mW/cc to 99 mW/cc.

6. The magnetic core according to claim 1, wherein the magnetic core has an initial permeability of 3,000 or more.

7. The magnetic core according to claim 1, wherein an atomic ratio of the manganese (Mn) component to the zinc (Zn) component ranges from 4.40 to 4.60.

8. The magnetic core according to claim 1, wherein the magnetic ion agent comprises a compound (Fe+Co) of iron (Fe) and cobalt (Co).

9. The magnetic core according to claim 8, wherein an atomic ratio of the compound (Fe+Co) of iron (Fe) and cobalt (Co) of the magnetic ion agent ranges from 2.08 to 2.10.

10. The magnetic core according to claim 1, wherein an atomic ratio of the cobalt (Co) component with respect to a total atomic ratio of the main composition ranges from 0.005 to 0.01.

11. The magnetic core according to claim 1, wherein the non-magnetic additive comprises at least one of calcium oxide (CaO), niobium oxide (Nb₂O₃), or a mixture thereof.

12. The magnetic core according to claim 11, wherein a content of the calcium oxide (CaO) is 400 ppm to 600 ppm.

13. The magnetic core according to claim 11, wherein a content of the niobium oxide (Nb₂O₅) is 50 ppm to 600 ppm.

14. A magnetic core having the following results of WD-XRF (wavelength dispersive-X-ray fluorescence) analysis:
a weight ratio of manganese oxide (MnO) of 21.2 wt % to 21.6 wt %;
a weight ratio of zinc oxide (ZnO) of 5.7 wt % to 6.1 wt %;
a weight ratio of iron oxide (Fe₂O₃) of 72 wt % to 72.7 wt %;
a weight ratio of cobalt oxide (Co₃O₄) of 0.3 wt % to 0.4 wt %;
a content of calcium oxide (CaO) of 400 ppm to 600 ppm; and
a content of niobium oxide (Nb₂O₅) of 50 ppm to 600 ppm.

15. The magnetic core according to claim 14, wherein a change in the core loss is less than 100 mW/cc at 25° C. to 140° C.

16. The magnetic core according to claim 15, wherein the change in the core loss ranges from 60 mW/cc to 99 mW/cc.

17. The magnetic core according to claim 16, wherein the magnetic core has an initial permeability of 3,003 to 4,540.
